(19) United States
(12) Patent Application Publication
(10) Pub. No.: US 2017/0011211 A1
(43) Pub. Date: Jan. 12, 2017

(54) Portable Phone with Eye Detecting Module

(71) Applicants: Mei Ling LO, Taipei (TW); Kuo-Ching CHIANG, Taipei (TW)

(72) Inventors: Mei Ling LO, Taipei (TW); Kuo-Ching CHIANG, Taipei (TW)

(21) Appl. No.: 15/249,471

(22) Filed: Aug. 28, 2016

Related U.S. Application Data
(63) Continuation of application No. 14/108,363, filed on Dec. 17, 2013.

(51) Int. Cl. G06F 21/32; G06K 9/00; G10L 17/22; H04L 12/58

(52) U.S. Cl. CPC G06F 21/32; H04L 51/10; G06K 9/00604; G06K 9/00617; G06K 9/00013; G06K 9/00087; G06K 9/00288; G10L 17/22; G06K 9/00926

(57) ABSTRACT

A portable phone includes a control unit, a first communication module coupled to the control unit, and a second communication module coupled to the control unit. A touch screen and a display are formed on the portable device; memory is coupled to the control unit to store an application. An image capturing device is coupled to the processing unit, and an eye-detecting illumination is formed on the portable device to detect user's eye. An eye-sensor is formed on the portable phone to sense the detected light from the user's eye for generating an eye image; an eye characteristic recognition module is provided within the portable device to compare a template in the portable phone with the eye image; wherein the application is accessed after the eye image matches with the template. A template refreshing system is provided to refresh an old template by a new template.

### CROSS REFERENCE TO RELATED APPLICATIONS

This application is a Continuation application of U.S. patent application Ser. No. 14/108,363, filed on Dec. 17, 2013. The content of the above-mentioned patent applications is hereby incorporated by reference herein in its entirety and made a part of this specification.

### TECHNICAL FIELD

The present invention relates generally to a mobile phone, and more particularly to a mobile phone with a security system.

### BACKGROUND OF THE RELATED ARTS

Telecommunication and internet follow the tread to develop more convenient product and service to the market. The communication is, therefore, booming day by day. The network, mobile device are the essential facility and device for the human daily life. The network service provider and device maker are continuously to offer better service and solution to the user. The number of devices that individuals use for communications and messaging has also multiplied. Such devices include computers, wireless phones or tablet. The application or software is very useful to mobile phone user. It may offer several functions includes mail, message, dialing. Service message or mail providers are drivers that connect client applications to a messaging system. For example, MAPI service providers include: message store providers, address book or directory providers, and message transport providers. The service providers work with MAPI to create and send messages. When the client sent the message, the message store provider will check recipient that has valid address. Address book providers handle access to directory information. When an incoming message is detected, the transport provider informs the spooler and the message is delivered to the appropriate message store. To handle outgoing messages, the message store moves the message to the outbound queue, and the spooler transfers it to the appropriate transport providers. The first thing before employing the mobile phone is to switch on the phone, and enter the security password. However, the password of the current electronic system is based on text. It is not convenient and not safe to the user.

### SUMMARY

A portable phone includes a control unit, a first communication module coupled to the control unit, and a second communication module coupled to the control unit. A touch screen and a display are formed on the portable device; memory is coupled to the control unit to store an application. An image capturing device is coupled to the processing unit, and an eye-detecting illumination is formed on the portable device to detect user's eye. An eye-sensor is formed on the portable phone to sense the detected light from the user's eye for generating an eye image; an eye characteristic recognition module is provided within the portable device to compare a template in the portable phone with the eye image; wherein the application is accessed after the eye image matches with the template. A template refreshing system is provided to refresh an old template by a new template.

In another example, a microphone is activated after said eye image matches with said template. The portable phone includes a voiceprint recognition module, or/and a fingerprint capture device. In some examples, the portable phone includes a fingerprint recognition module and/or a face recognition module. A security of said portable phone is released after said eye image matches with said template.

In further example, the first bio characteristic is replaced by the second bio characteristic to refresh a template. The template includes fingerprint, eye image or face image. The bio-characteristic capturing device includes image sensor or microphone. The template includes voiceprint, the bio-characteristic capturing device includes microphone.

Address book providers handle access to directory information. Message store providers handle the storage and retrieval of messages and other information for the users of client application.

### BRIEF DESCRIPTION OF THE DRAWINGS

FIG. 1 shows a diagram of a computing system according to the present invention.

FIG. 2 shows a flow chart for accessing the e-mail system according to the present invention.

### DETAILED DESCRIPTION

The present invention relates generally to portable device security system. The portable device includes but not limited to cellular phone, PDA (personal digital assistant), smart phone, notebook, tablet and the equivalent thereof. The wireless communication portable device may include dual-way transmission protocol, such as GSM, CDMA, WCDMA, 4 G or higher specification.

The present invention relates to mobile phone security system. It can be applied to any suitable OS system, for instance, iOS, android and son on. The security system may be employed for the security of any applications or software. Some of the examples includes, but not limited to mail system, chat application, OS, The mail system includes local mail or web mail system such as Google mail, hot mail, yahoo mail and any other web mail system. In one embodiment, the electronic mail system is incorporate with computing platform and operation system. Under such scheme, the electronic mail module may be utilized by the user for transmitting, receiving electronic mail. The electronic mail system includes pluralities of sub-modules, for example, including a calendar manager, a task list manager, a contact manager, a message manager (e-mail), and a notes manager. Although the preferred embodiment will be generally described in the context of a program and an operating system running on a personal computer, table, and smart phone those skilled in the art will recognize that the present invention also can be implemented in conjunction with other program modules for other types of computers, or operation system Android, iOS. The electronic mail system is developed over ten years. However, these messages are simple text messages and are presented by text.

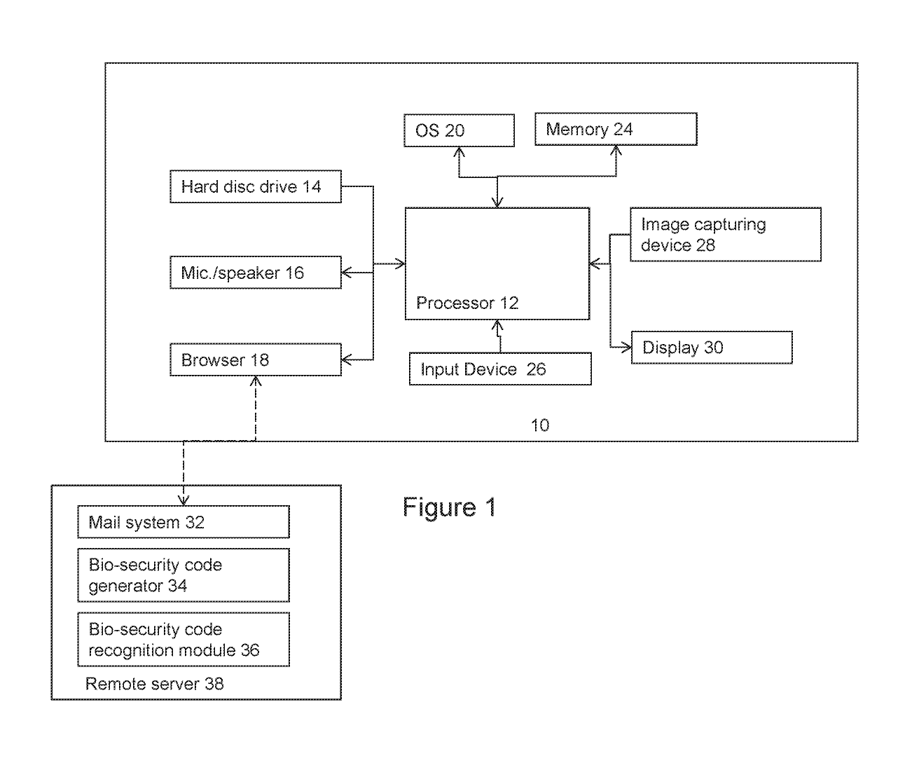

The computing system generally includes a control unit (such as CPU), memory, display, I/O etc. The present invention may be applied to the heterogeneous distributed computing environment, for instance, remote server. As shown in FIG. 1, the portable communication device 10 such as computer, note book, tablet, smart phone, includes a processing unit 12 and memory 24, which is coupled to the processing unit 12. The portable communication device 10, for example, the notebook may have BIOS which is a set of basic routines to transfer information between elements within the portable communication device 10. Those skilled in the art will also appreciate that the present invention may be used for computing devices without BIOS. A hard disk drive 14 is coupled to the processing unit 12. Some of the portable communication device devices omit the hard drive. A user inputs instruction to the portable communication device 10 via input devices 26, such as a keyboard, mouse or touch screen. A display 30 is connected to the processing unit 14. OS 20 and applications 18 such as browser are stored on the computer readable medium. Microphone and speaker 16 are coupled to the processing unit 14, an image capturing device 28 is also coupled to the processing unit 14. Typically, the image capturing device 28 may be the front and/or the rear cameras.

An Internet email message consists of three components, the message envelope, the message header, and the message body. The message header contains control information, including, minimally, an originator's email address and one or more recipient addresses. Usually descriptive information is also added. Messages are exchanged between hosts using the Simple Mail Transfer Protocol with software programs; and delivered to a mail store by programs called mail delivery agents. Users can retrieve their messages from servers using standard protocols such as POP or IMAP. Webmail interfaces allow users to access their mail with any standard web browser, from any computer, rather than relying on an email client. mail user agents (MUAs) used by users is provided for retrieving, reading, and managing email. Mail can be stored on the client, on the server side, or in both places. Server-side storage is often in a proprietary format but since access is through a standard protocol such as IMAP, moving email from one server to another can be done with any MUA supporting the protocol.

Web-based email (webmail) is the type of email. Many free email providers host their servers as web-based email (e.g. Hot Mail, Gmail, Outlook and Yahoo! Mail). This allows users to log into the email account by using a web browser to send and receive their email. POP3 is the acronym for Post Office Protocol 3. It is a leading email account type on the Internet. In a POP3 email account, email messages are downloaded to the client device and then they are deleted from the mail server. Other protocols IMAP, (Internet Message Access Protocol) provide more complete and complex remote access to typical mailbox operations. Another protocols is called Messaging Application Programming Interface (MAPI). The MAPI architecture is designed to make it easy for programmers to write messaging-enabled applications that are independent of the underlying messaging system. MAPI provides high-level function that can be used to implement sophisticated messaging features with a relatively small amount of code. The code deals with functions, for example, sending, receiving, and addressing messages. The underlying messaging system is completely transparent. Those skilled in the art will recognize that the present invention may be applied to any operation system and any mail protocol.

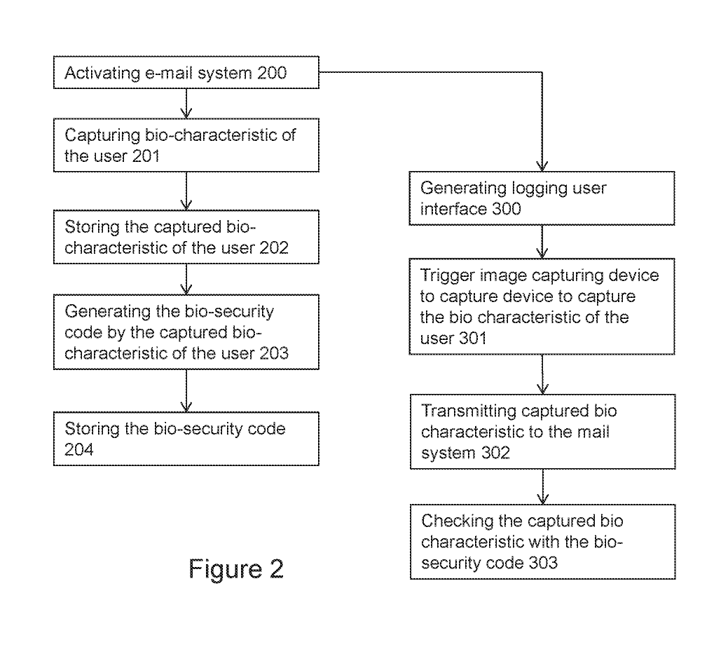

The present invention includes a step of activating the system (application) 200 from the user terminal device 10. The system may be a local system or web-based system as shown in FIG. 2. The next is to prepare the security code for logging the system. In one embodiment, the invention introduces the bio-characteristic as the security code instead of text based password. The system activates the device to collect the bio-characteristic of the user. The bio characteristic includes face image, eye image, fingerprint or voice bio-characteristic. The face image, eye image, fingerprint bio-characteristic can be captured by image capturing device 28, the voice bio-characteristic is collected by microphone 16. After the template of the bio-characteristic is collected, the bio-characteristic is stored in local system or remote system 202, thereby generating the bio-security code by the bio-security code generator 34 in step 203. Then, the bio-security code is stored in local system or remote system.

If the user would like to send or receive message from the mail system 32 in the server 38, please refer to FIG. 2. After the user activates the system, the mail system 38 generates and transmits the user interface to the user terminal and displayed on the display 30 in step 300. The user bio-characteristic is captured by the image capturing device 28 or the microphone 16 in step 301. The user may not input the password and the user account due to the user oneself is actually the real “user account” and “password”. The captured bio-characteristic is transmitted to the mail system in the remote server or local system in step 302, followed by compare the stored bio-security code with the currently captured bio-characteristic by the bio-security code recognition module 36 in the remote server 38 in step 303. Preferably, dual source LED is used to project two spatially separated spots at the subject's pupil. The dual source LED is constructed by placing two LED side by side on the panel of the portable device. Back light from the subject's eye is detected by a sensor directly or via other optical mirror or lens. Another method is to detect the user image by the sensor. The sensor could be optical sensor such as CMOS sensor or CCD.

The method associated with the present invention includes the steps of activating the e-mail system. The electronic system includes text, or audio/video e-mail generator. The next step is to activate the e-mail generator to generate the e-mail, followed by triggering at least one of the microphone and digital camera or the like. The next step is to generate and prepare the text, audio/video e-mail by the text, or audio/video e-mail generator. Then, the user may transmit the text, or audio/video e-mail. A message store provider initiates the sending process, and delivers it to the appropriate transport provider. The transport provider gives the message to its messaging system, which sends it to the intended recipient(s). When the user opens the e-mail, it displays by the audio/video type instead of conventional text. The receiver may receive the audio message through the output of the speaker and the video signal is displayed on the display. Accordingly, the text message may be shown on the display as well. When the user would like to send the text, audio/video e-mail and input the instruction of creating a new mail, the user may initiate the generation of audio/video mail, then inputs the receipt address, or vice verse. The mentioned method above may be employed for the instant chat application for the logging.

Therefore, the e-mail system (instant chat application) is different from the prior message system. The method can be used in local mail system, web mail system, instant message system or other type of applications, software. Alternatively, the present invention may be integrated into the mobile phone terminal, table or PDA, thereby allowing the user may receive the message portably, and the user may omit to input the text word or message by one hand. The user may input the message by voice and/or video. If the system is based on the web base, the user may couple to the web mail service provider through the browser before receiving or sending mails. As mentioned, the wireless communication portable device may include dual-way transmission protocol, such as GSM, CDMA or 4G However, if the video data is required to be received and transmitted, simultaneously, the mobile communication protocol is well-known to be at least third generation mobile protocol, such as WCDMA or higher. From above, the mobile phone with at least third generation mobile protocol and the message generator comprises the e-mail generator provided to generate an e-mail or instant message. The message is processed by said generator and transmitted and received by at least third generation mobile protocol. The present invention may allow the user portably activate the mobile phone without inputting the text based password.

If the mobile phone includes internet work linking capability, namely, it integrated WLAN module into the device, it may couple to the network through the network linking module, for example WiFi, WiMax, 802.11 standard. The present invention changes the type of password. It providers better communication interface. Therefore, the user may send a true “password” by bio-characteristics. Thus, it offers better security interface for the user to login the system of the mobile phone. It also may allow the blind people to send a voice mail (message) even if he cannot see the keyboard or touch screen. When the user activate the message or system, the bio-characteristic capturing device will be triggered to automatically fetch the current bio-characteristic of the user, followed by accessing the message or mail system when the system identifies the user. Further, the user may refresh the template by using new captured bio-characteristic. The bio-characteristic may be changed due to the user gets older, for example, the face image maybe changed. Alternatively, the system maybe set to automatically alter the old bio-characteristic template by new captured bio-characteristic within one predetermined cycle.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

We claim:

1. A portable phone, comprising:
a control unit;
a first communication module coupled to said control unit;
a second communication module coupled to said control unit;
a touch screen and a display formed on said portable device;
a memory coupled to said control unit to store an application;
an image capturing device coupled to said processing unit;
an eye-detecting illumination formed on said portable device to detect user's eye;
an eye-sensor formed on said portable phone to sense said detected light from said user's eye for generating an eye image;
an eye characteristic recognition module within said portable device to compare a template in said portable phone with said eye image; and
wherein said application is accessed after said eye image matches with said template.

2. The portable phone of claim 1, wherein said portable phone includes a voiceprint recognition module.

3. The portable phone of claim 1, wherein said portable phone includes a fingerprint capture device.

4. The portable phone of claim 3, wherein said portable phone includes a fingerprint recognition module.

5. The portable phone of claim 1, wherein said portable phone includes a face recognition module.

6. The portable phone of claim 5, wherein a face image is captured by said image capturing device.

7. The portable phone 1, further comprising a template refreshing system to refresh an old template by a new template.

8. A portable phone, comprising:
a control unit;
a first communication module coupled to said control unit;
a second communication module coupled to said control unit;
a touch screen and a display formed on said portable device;
a microphone coupled to said control unit to input voice signal;
an image capturing device coupled to said processing unit;
an eye-detecting illumination formed on said portable device to detect user's eye;
an eye-sensor formed on said portable phone to sense said detected light from said user's eye for generating an eye image;
an eye characteristic recognition module within said portable device to compare a template in said portable phone with said eye image; and
wherein said microphone is activated after said eye image matches with said template.

9. The portable phone of claim 8, wherein said portable phone includes a voiceprint recognition module.

10. The portable phone of claim 8, wherein said portable phone includes a fingerprint capture device.

11. The portable phone of claim 10, wherein said portable phone includes a fingerprint recognition module.

12. The portable phone of claim 8, wherein said portable phone includes a face recognition module.

13. The portable phone of claim 12, wherein a face image is captured by said image capturing device.

14. The portable phone 12, further comprising a template refreshing system to refresh an old template by a new template.

15. A portable phone, comprising:
a control unit;
a first communication module coupled to said control unit;
a second communication module coupled to said control unit;
a touch screen and a display formed on said portable device;
a memory coupled to said control unit to store an application;
an image capturing device coupled to said processing unit;
an eye-detecting illumination formed on said portable device to detect user's eye;
an eye-sensor formed on said portable phone to sense said detected light from said user's eye for generating an eye image;
an eye characteristic recognition module within said portable device to compare a template in said portable phone with said eye image; and
a security of said portable phone is released after said eye image matches with said template.

16. The portable phone of claim 15, wherein said portable phone includes a voiceprint recognition module.

17. The portable phone of claim 15, wherein said portable phone includes a fingerprint capture device.

18. The portable phone of claim 17, wherein said portable phone includes a fingerprint recognition module.

19. The portable phone of claim 15, wherein said portable phone includes a face recognition module.

20. The portable phone of claim 15, further comprising a template refreshing system to refresh an old template by a new template.
